(19) United States
(12) Patent Application Publication
(10) Pub. No.: US 2023/0195834 A1
(43) Pub. Date: Jun. 22, 2023

(54) COMPUTER-READABLE RECORDING MEDIUM STORING ARITHMETIC PROCESSING PROGRAM, ARITHMETIC PROCESSING METHOD, AND ARITHMETIC PROCESSING APPARATUS

(71) Applicant: Fujitsu Limited, Kawasaki-shi (JP)

(72) Inventor: MASAKI ARAI, Kawasaki (JP)

(73) Assignee: Fujitsu Limited, Kawasaki-shi (JP)

(21) Appl. No.: 17/957,819

(22) Filed: Sep. 30, 2022

(30) Foreign Application Priority Data
Dec. 16, 2021 (JP) 2021-203792

(51) Int. Cl. G06F 17/16

(52) U.S. Cl. CPC G06F 17/16

(57) ABSTRACT

A non-transitory computer-readable recording medium storing an arithmetic processing program that causes a computer to execute a process, the process includes, in a case of obtaining a result of product (r=A×v) of a matrix A expressed in a sparse matrix format and a vector v, grouping rows with a column of non-zero data within a range that does not exceed a slot size of a scratchpad memory, allocating a slot to each column of the non-zero data in the grouped rows, and transferring, at a time of processing the rows for each group, data of the vector v that corresponds to each column to the slot allocated to each column in processing of a first row of the group.

### CROSS-REFERENCE TO RELATED APPLICATION

This application is based upon and claims the benefit of priority of the prior Japanese Patent Application No. 2021-203792, filed on Dec. 16, 2021, the entire contents of which are incorporated herein by reference.

### FIELD

The embodiment discussed herein is related to an arithmetic processing program and the like having an architecture that streamlines data transfer.

### BACKGROUND

There is, as a type of matrices, a sparse matrix in which most of data elements included in the matrix are zero. There is a data structure in which zero-valued elements are deleted from a dense matrix as a format for expressing the sparse matrix. For example, the sparse matrix format is represented by a data structure including non-zero elements and positional information of each element by removing zero-valued elements from the matrix data. Examples of the sparse matrix format include a Compressed Row Storage (CSR) format.

The traffic between a CPU and a memory may be significantly reduced when the matrix has many zero-valued elements, which may speed up the program. Meanwhile, the program execution time may significantly change depending on how the zero values are distributed in the matrix. For example, there is a problem that it is difficult to efficiently use a cache memory and it is difficult to tune the program.

Meanwhile, a scratchpad memory is a memory connected to a core of the CPU separately from the cache memory. In a case of using the scratchpad memory, a memory area to be used only in the scratchpad memory is secured, and the program accesses the address of the secured memory area. The scratchpad memory has a distance between the core and the memory shorter than that in the case of using a cache memory included in a normal CPU, whereby it has an advantage that data may be used with low latency, for example. Furthermore, the scratchpad memory does not need a tag check and Least Recently Used (LRU) management required by the cache memory, whereby it has an advantage that power consumption may be reduced.

There has been disclosed a technique of using the scratchpad memory for arithmetic processing of the sparse matrix.

Japanese Laid-open Patent Publication No. 2020-166368, Japanese Laid-open Patent Publication No. 2002-108837, U.S. Patent Application Publication No. 2002/0040428, Japanese Laid-open Patent Publication No. 2021-51727, and “Compiler-Based Approach for Exploiting Scratch-Pad in Presence of Irregular Array Access”, Design, Automation and Test in Europe Conference and Exhibition (DATE '05), 2005 are disclosed as related art.

### SUMMARY

According to an aspect of the embodiments, a non-transitory computer-readable recording medium storing an arithmetic processing program that causes a computer to execute a process, the process includes, in a case of obtaining a result of product (r=A×v) of a matrix A expressed in a sparse matrix format and a vector v, grouping rows with a column of non-zero data within a range that does not exceed a slot size of a scratchpad memory, allocating a slot to each column of the non-zero data in the grouped rows, and transferring, at a time of processing the rows for each group, data of the vector v that corresponds to each column to the slot allocated to each column in processing of a first row of the group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an arithmetic processing device according to an embodiment;

FIG. 2 is a diagram illustrating a pre-conversion program;

FIG. 3 is a diagram illustrating a post-conversion program;

FIG. 4 is a diagram illustrating an exemplary sparse matrix;

FIG. 5 is a diagram illustrating sparse matrix information (CSR format);

FIG. 6 is a diagram illustrating row access information;

FIG. 7A is a diagram (1) illustrating an example of a row sorting process;

FIG. 7B is a diagram (2) illustrating an example of the row sorting process;

FIG. 7C is a diagram (3) illustrating an example of the row sorting process;

FIG. 7D is a diagram (4) illustrating an example of the row sorting process;

FIG. 7E is a diagram (5) illustrating an example of the row sorting process;

FIG. 7F is a diagram (6) illustrating an example of the row sorting process;

FIG. 7G is a diagram (7) illustrating an example of the row sorting process;

FIG. 7H is a diagram (8) illustrating an example of the row sorting process;

FIG. 7I is a diagram (9) illustrating an example of the row sorting process;

FIG. 8 is a diagram illustrating row sorting information;

FIG. 9 is a diagram illustrating the sparse matrix information (CSR format) after row sorting;

FIG. 10 is a diagram illustrating row grouping information;

FIG. 11 is a diagram illustrating data rearrangement information;

FIG. 12 is a diagram illustrating slot allocation information;

FIG. 13 is a diagram illustrating slot vector information;

FIG. 14 is a diagram illustrating SPM setting information;

FIG. 15 is a diagram illustrating an exemplary flowchart of an initialization process (init_SPM) according to the embodiment;

FIG. 16 is a diagram illustrating an exemplary flowchart of the row sorting process according to the embodiment;

FIG. 17 is a diagram illustrating an exemplary flowchart of a data transfer process (setup_SPM) according to the embodiment;

FIG. 18 is a diagram illustrating an exemplary computer that executes an arithmetic processing program;

FIG. 19 is a diagram illustrating a reference example of a matrix vector product program of a dense matrix; and

FIG. 20 is a diagram illustrating a reference example of the matrix vector product program of the sparse matrix (CSR format).

### DESCRIPTION OF EMBODIMENTS

There is a problem that it is difficult to efficiently use a scratchpad memory at a time of calculating an arithmetic equation indicating a product of a sparse matrix and a vector. For example, the size of the vector v is usually larger than the size of the scratchpad memory at a time of calculating an arithmetic equation r=A×v of a matrix A expressed in a sparse matrix format. Furthermore, since element referencing of the vector v is indirect referencing, a hardware prediction function may not be used. Therefore, it is difficult to efficiently use the scratchpad memory. Furthermore, the scratchpad memory may be used by transferring necessary data of the vector v from a memory to the scratchpad memory at the timing of element referencing of the vector v. However, the scratchpad memory may not be efficiently used in such a process.

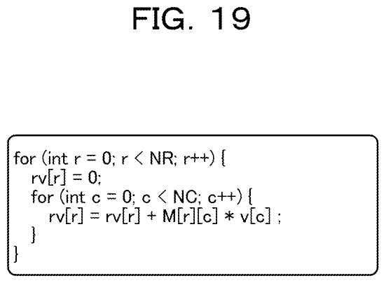

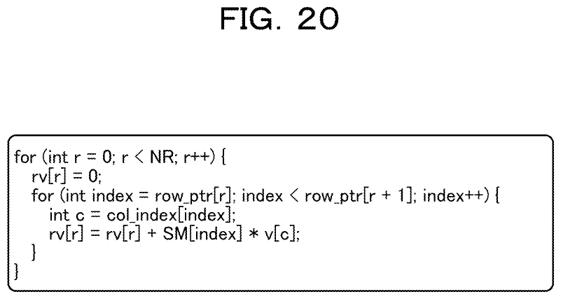

Such a problem will be specifically described. FIG. 19 is a diagram illustrating a reference example of a matrix vector product program of a dense matrix. Here, a variable M is the dense matrix. With respect to this matrix vector product program, a matrix vector product program of a sparse matrix SM that expresses the dense matrix M in a CSR format is as illustrated in FIG. 20. FIG. 20 is a diagram illustrating a reference example of the matrix vector product program of the sparse matrix (CSR format). In the program illustrated in FIG. 20, memory referencing of indirect referencing format is used in which a vector col_index[index] is specified for an index c indicating the position of the vector v. For example, the element referencing of the vector v is indirect referencing. Accordingly, the hardware prediction function may not be used. In addition, the elements of the vector v referenced in a loop usually exist in discrete positions in the memory. Accordingly, a cache of a CPU may not be efficiently used, and the execution efficiency of the sparse matrix program illustrated in FIG. 20 is significantly lower than that of the dense matrix program illustrated in FIG. 19.

With the scratchpad memory used, it becomes possible to achieve lower power consumption and speeding up of the program. However, since data such as the vector v of the program illustrated in FIG. 20 usually has a size of the vector v larger than that of the scratchpad memory, it may not be entirely arranged in the scratchpad memory, whereby it is difficult to efficiently use the scratchpad memory.

Hereinafter, a technical embodiment capable of efficiently use the scratchpad memory at a time of calculating an arithmetic equation indicating a product of a sparse matrix and a vector will be described in detail with reference to the drawings. Note that the present disclosure is not limited to the embodiment.

### Embodiment

[Functional Configuration of Arithmetic Processing Device According to Embodiment]

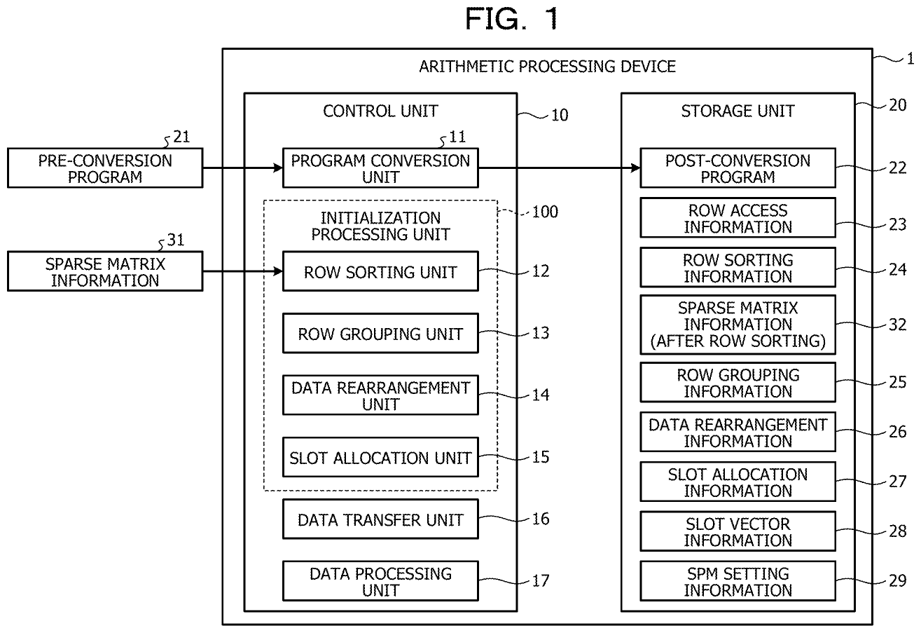

FIG. 1 is a block diagram illustrating an exemplary functional configuration of an arithmetic processing device according to an embodiment. An arithmetic processing device 1 illustrated in FIG. 1 converts a matrix vector product program of a sparse matrix as follows at a time of calculating an arithmetic equation r=A×v of a matrix A expressed in a sparse matrix format. For example, the arithmetic processing device 1 generates, for each row, a set of columns of non-zero data required for processing of each row of the sparse matrix. The arithmetic processing device 1 sorts the rows to reuse the data of v in the scratchpad memory. Then, the arithmetic processing device 1 groups the rows within a range where the scratchpad memory does not overflow. Then, the arithmetic processing device 1 transfers the data of v to the scratchpad memory and performs an operation with the grouped plurality of rows as one unit. As a result, the arithmetic processing device 1 is enabled to use the scratchpad memory for processing the data of v.

The arithmetic processing device 1 includes a control unit 10 and a storage unit 20. The control unit 10 corresponds to an electronic circuit such as a Central Processing Unit (CPU). Additionally, the control unit 10 includes an internal memory for storing programs defining various processing procedures and control data, and executes a variety of types of processing using the programs and the control data. The control unit 10 includes a program conversion unit 11, an initialization processing unit 100, a data transfer unit 16, and a data processing unit 17. Note that the initialization processing unit 100 is a processing unit to be executed by an SPM initialization function init_SPM, which will be described later.

The storage unit 20 is, for example, a semiconductor memory device such as a Random Access Memory (RAM) or a flash memory, or a storage device such as a hard disk or an optical disk. The storage unit 20 contains a post-conversion program 22, row access information 23, row sorting information 24, sparse matrix information (after row sorting) 32, row grouping information 25, data rearrangement information 26, slot allocation information 27, slot vector information 28, and SPM setting information 29. Note that the SPM is an abbreviation of the scratchpad memory. Hereinafter, the scratchpad memory may be referred to as “SPM”.

The program conversion unit 11 converts a pre-conversion program 21 into the post-conversion program 22.

The post-conversion program 22 indicates a program after the pre-conversion program 21 is converted at a time of calculating a product of a vector and a sparse matrix expressed in the sparse matrix format. The pre-conversion program 21 indicates a program for calculating a product of a vector and a sparse matrix that expresses a dense matrix in a CSR format, which is one of sparse matrix formats.

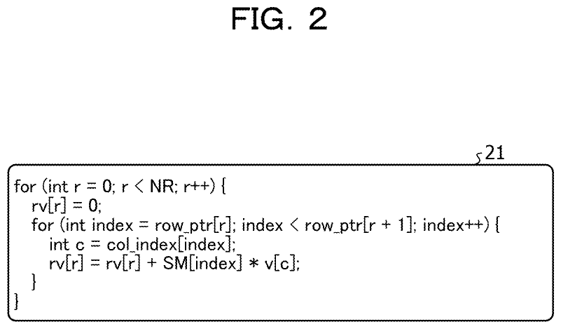

FIG. 2 is a diagram illustrating a pre-conversion program. In FIG. 2, SM represents a sparse matrix expressed in the CSR format. In FIG. 2, v represents a vector to be subject to a product operation with the sparse matrix. Here, memory referencing of indirect referencing format is used in which a vector col_index[index] is specified for an index c indicating the position of the vector v. For example, the element referencing of the vector v is indirect referencing.

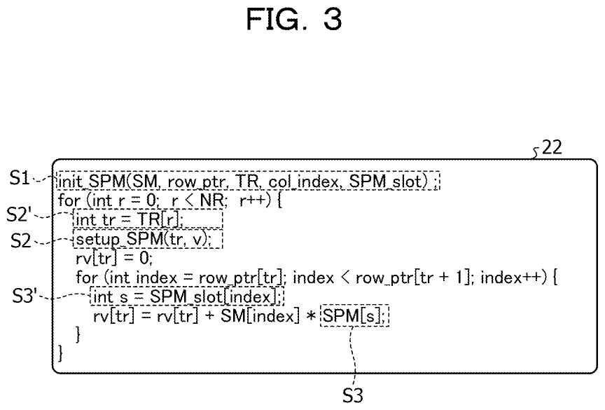

Here, a procedure in which the program conversion unit 11 generates the post-conversion program 22 that uses the SPM for processing the vector v used by the pre-conversion program 21 illustrated in FIG. 2 will be described with reference to FIG. 3. FIG. 3 is a diagram illustrating a post-conversion program.

First, as indicated by a reference sign S1, the program conversion unit 11 adds the following call to the SPM initialization function init_SPM( ) to the beginning part of the pre-conversion program 21 illustrated in FIG. 2. The SPM initialization function init_SPM( ) checks sparse matrix data at a time of executing the program, sorts the rows, and generates information for using the SPM. The information generated here is generated only once at the time execution. Note that SM, row_ptr, and col_index represent sparse matrix information expressed in the CSR format. An array for storing row numbers after sorting the rows of the sparse matrix is represented by TR. Slot vector information of the SPM is represented by SPM_slot. init_SPM (SM, row_ptr, TR, col_index, SPM_slot);

Next, as indicated by a reference sign S2, the program conversion unit 11 adds the following call to an SPM setting function setup_SPM( ) to the beginning part of the loop body of the control loop variable r in the pre-conversion program 21 illustrated in FIG. 2. The function setup_SPM( ) sets up the SPM at the time of executing the program. Furthermore, as indicated by a reference sign S2′, the program conversion unit 11 changes the row variable r to a converted row variable tr using TR to reflect the sorting of the rows of the sparse matrix as follows. int tr=TR[r]; setup_SPM(tr, v);

Next, as indicated by a reference sign S3, the program conversion unit 11 replaces the referencing of the vector v with the variable SPM representing the scratchpad memory, and replaces a variable c with a slot variable s in the pre-conversion program 21 illustrated in FIG. 2. For example, v[c] of the pre-conversion program 21 is replaced with SPM[s] of the post-conversion program 22. Furthermore, as indicated by a reference sign S3′, the program conversion unit 11 replaces index vector information with slot vector information of the SPM as follows. Note that SPM_slot represents the slot vector information of the SPM, and the variable s is a slot variable. int s=SPM_slot[index];

Then, the program conversion unit 11 outputs the post-conversion program 22 as a program to be used for the product operation of the sparse matrix.

Returning to FIG. 1, the initialization processing unit 100 to be executed by the SPM initialization function init_SPM described in the post-conversion program 22 will be described. The initialization processing unit 100 includes a row sorting unit 12, a row grouping unit 13, a data rearrangement unit 14, and a slot allocation unit 15.

The row sorting unit 12 executes a sorting process of the rows of the sparse matrix. For example, the row sorting unit 12 obtains the position of non-zero data from sparse matrix information 31 that expresses the sparse matrix in the CSR format, and generates the row access information 23. The row access information 23 indicates set information of values of the variable c indicating elements (positions) of the vector v required for the processing of each row. For example, the row access information 23 may be referred to as set information of the values of the variable c indicating column numbers (positions) of non-zero data for each row number r. Then, the row sorting unit 12 refers to the row access information 23, sorts the rows to improve the reusability of the data of the vector v arranged in the SPM, and generates the row sorting information 24. For example, the row sorting unit 12 sorts the rows in such a manner that the degree of duplication of the non-zero data columns becomes higher, and generates the row sorting information 24. For example, the row sorting unit 12 sorts the rows in such a manner that the reusability of the data of the vector v to be multiplied by the non-zero data increases. The row sorting information 24 indicates set information of the values of the variable c indicating elements (positions) of the vector v required for the processing of each row after the row numbers are sorted. For example, the row sorting information 24 indicates set information of the values of the variable c indicating column numbers (positions) of the non-zero data for each row number r after the row numbers are sorted. Then, the row sorting unit 12 generates, from the row sorting information 24, the sparse matrix information 32 after the row sorting expressed in the CSR format. Note that details of the row sorting process will be described later.

The row grouping unit 13 groups the rows from the row sorting information 24 within a range not exceeding the number of slots of the SPM, and generates the row grouping information 25. As an example, when the number of slots is 12, the data of the vector v corresponding to the column of the non-zero data is arranged in each of the 12 slots. The row grouping information 25 indicates set information of the values of the variable c used in the group of the row numbers.

The data rearrangement unit 14 generates the data rearrangement information 26 for arranging the data of the vector v corresponding to the variable c required for the processing of the grouped rows in the SPM. The data rearrangement information 26 indicates information that associates a list of data already saved in the SPM with a list of data to be newly arranged (updated) in the SPM at the time point of starting the individual processes of the row number groups. For example, the data rearrangement information 26 indicates information that associates a list of values of the variable c corresponding to the data actually saved in the SPM with a list of values of the variable c corresponding to the data to be newly arranged (updated) in the SPM.

The slot allocation unit 15 generates the slot allocation information 27 from the data rearrangement information 26. The slot allocation information 27 indicates information used at the time of processing the grouped rows, which is information that associates the slot number with the value of the variable c for each row number group.

Furthermore, the slot allocation unit 15 generates the slot vector information 28 from the slot allocation information 27 and the sparse matrix information 32 after the row sorting expressed in the CSR format. The slot vector information 28 indicates information used to obtain the slot number from an index variable index obtained from the sparse matrix information 32 after the row sorting. The slot vector information 28 indicates SPM_slot in the post-conversion program 22 of FIG. 3. This is to obtain a slot number s from the index variable index instead of obtaining col_index from the index variable index. Then, the slot allocation unit 15 generates the SPM setting information 29 to be executed at the time of processing the grouped rows from the slot allocation information 27. The SPM setting information 29 indicates information in which a list of (slot number, value of variable c) is set for each row number group.

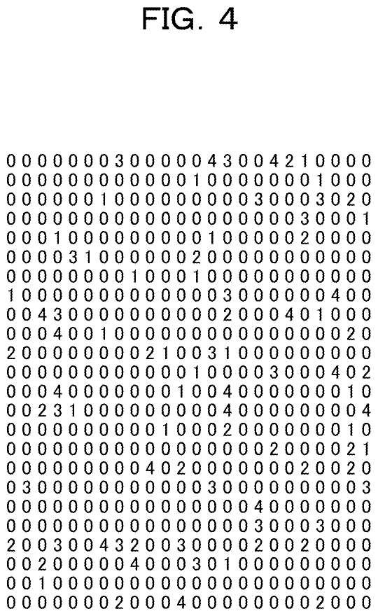

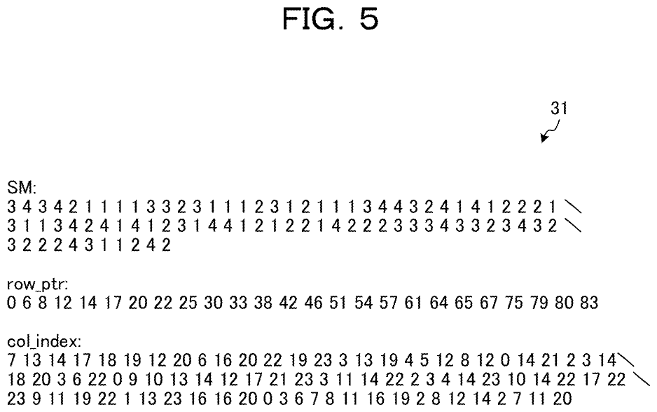

Here, a specific example of the initialization processing unit 100 according to the embodiment will be described. Here, it is assumed that the sparse matrix illustrated in FIG. 4 is expressed by the sparse matrix information 31 in the CSR format illustrated in FIG. 5. FIG. 4 is a diagram illustrating an example of the sparse matrix. FIG. 5 is a diagram illustrating the sparse matrix information (CSR format). In FIG. 5, row_ptr represents a pointer indicating the same row (row) with respect to SM and col_index. A list of values excluding zero values is represented by SM. A list of column numbers (col) of values excluding zero values is represented by col_index. As an example, in a case where row_ptr is “0 6 8 . . . ”, values from zeroth to less than sixth with respect to SM are values of non-zero data “3”, “4”, “3”, “4”, “2”, and “1” in the zeroth row, respectively. In addition, it is indicated that values from zeroth to less than sixth with respect to col_index are column numbers “7”, “13”, “14”, “17”, “18”, and “19” of non-zero data in the zeroth row, respectively.

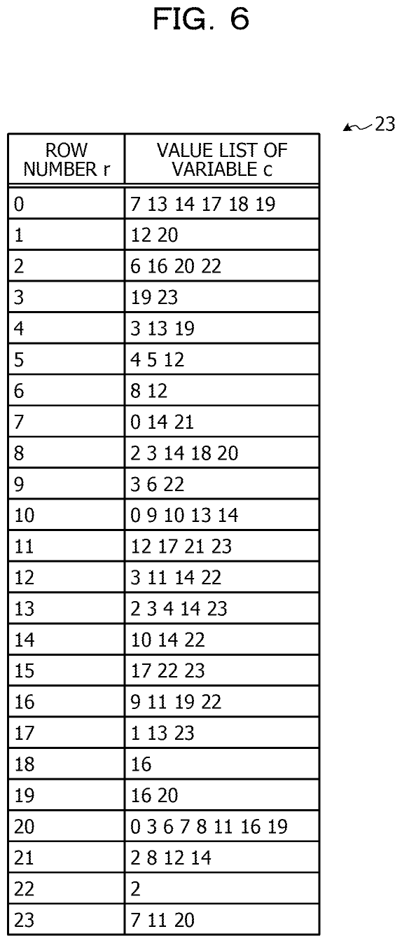

Under such circumstances, the row sorting unit 12 obtains the positions (column numbers) of the non-zero data of the sparse matrix from the sparse matrix information 31 expressed in the CSR format, and generates the row access information 23. Here, the row sorting unit 12 generates the row access information 23 illustrated in FIG. 6 from the sparse matrix information 31 illustrated in FIG. 5. FIG. 6 is a diagram illustrating the row access information. As illustrated in FIG. 6, the row access information 23 represents the values of the variable c indicating the column number col_index of the non-zero value for each row number. For example, the row access information 23 represents a list of the values of the variable c indicating the elements of the vector v required for the processing of each row for each row number. As an example, in a case where the row number r is “0”, “7 13 14 17 18 19” is set in the value list of the variable c indicating col_index. In a case where the row number r is “1”, “12 20” is set in the value list of the variable c indicating col_index.

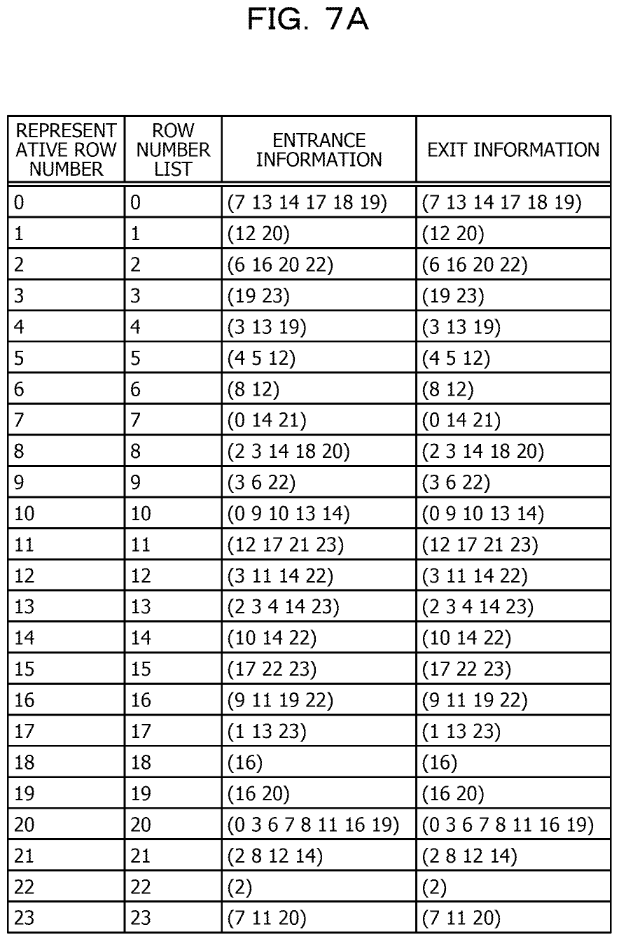

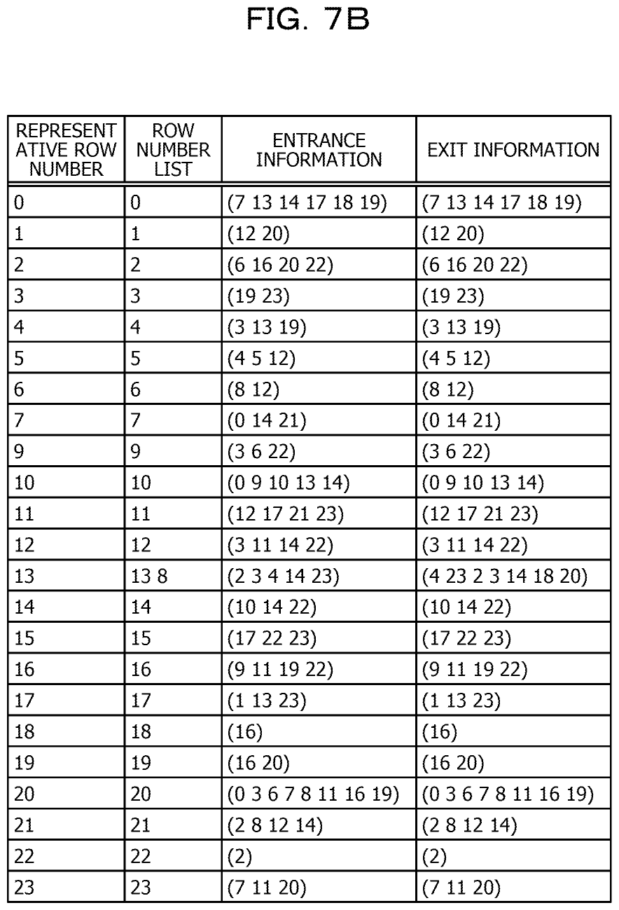

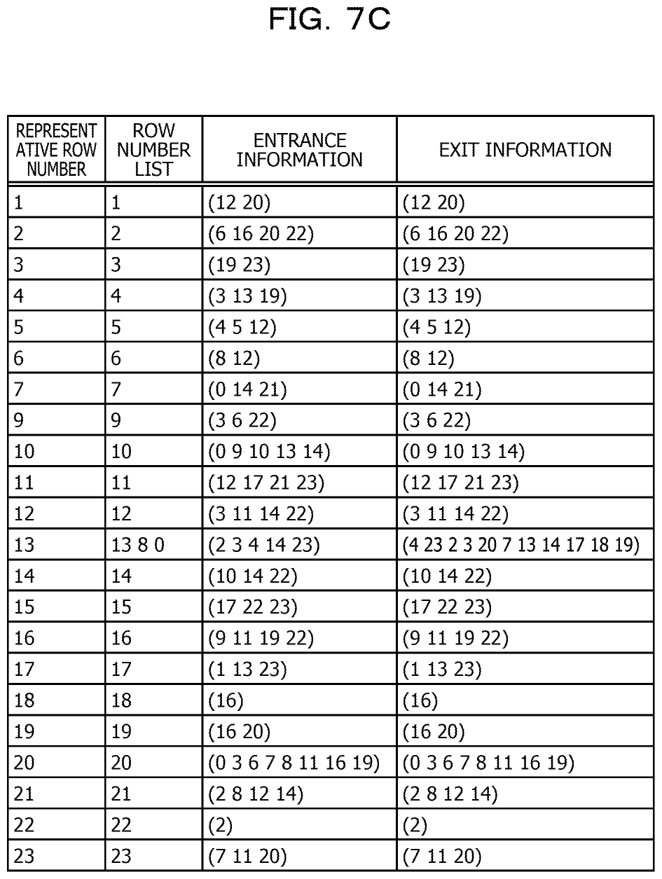

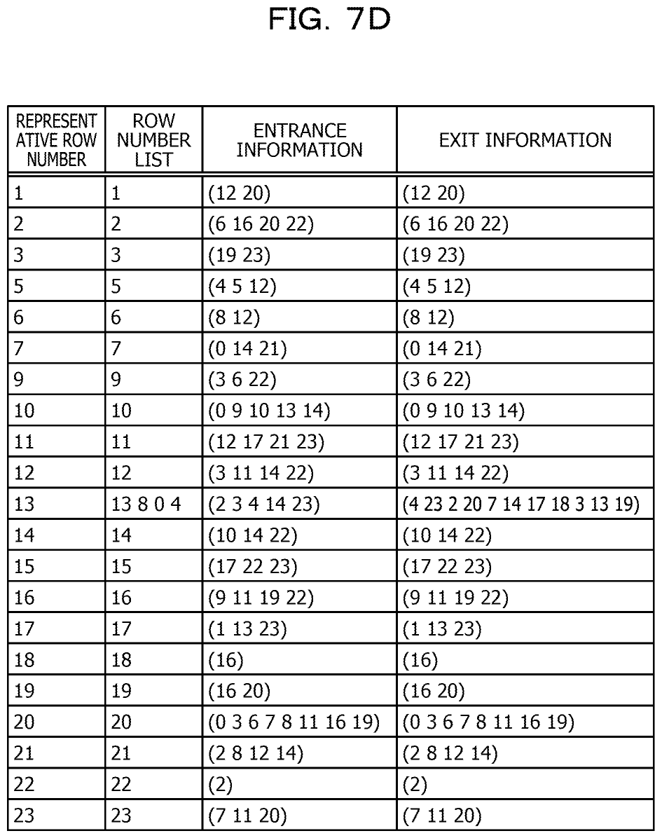

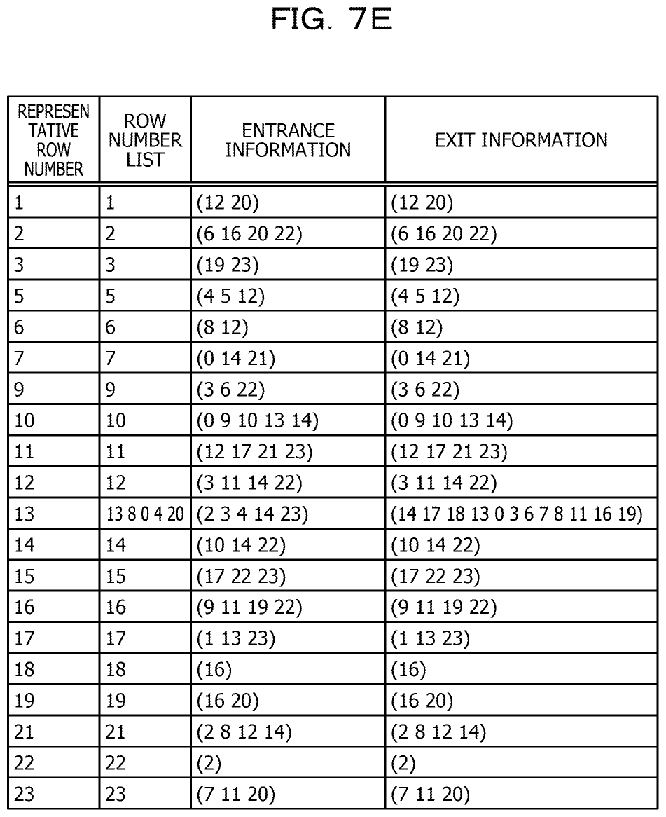

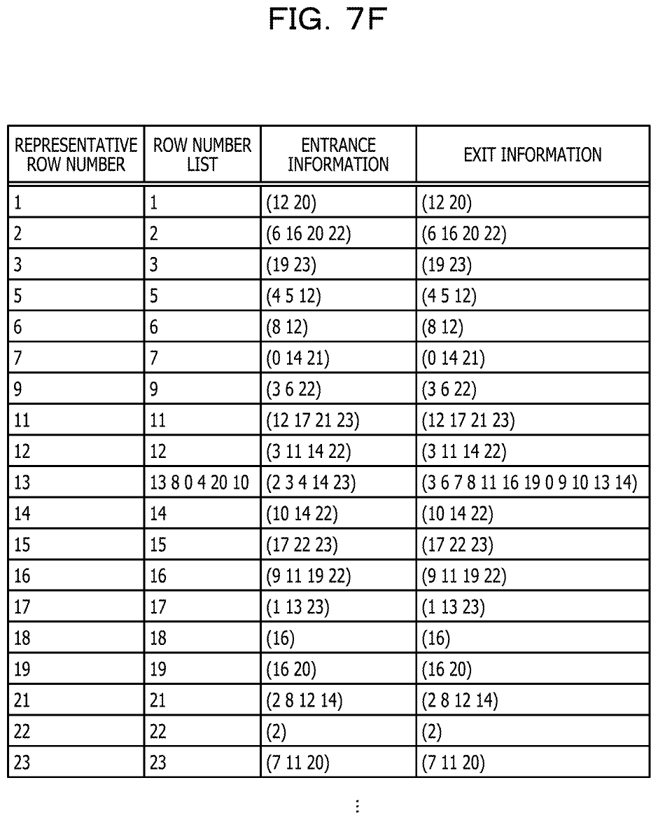

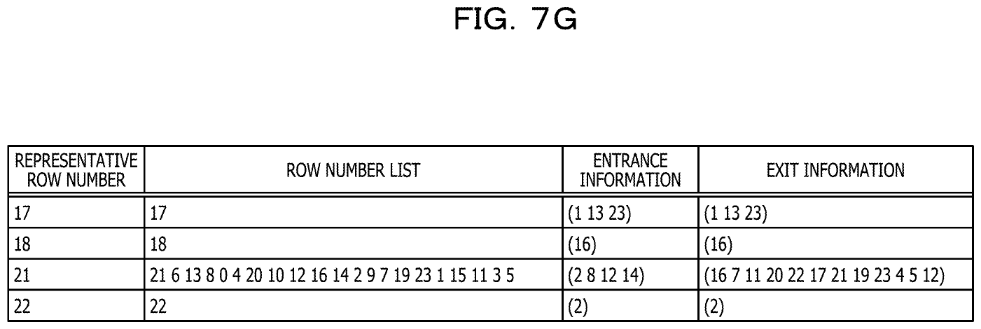

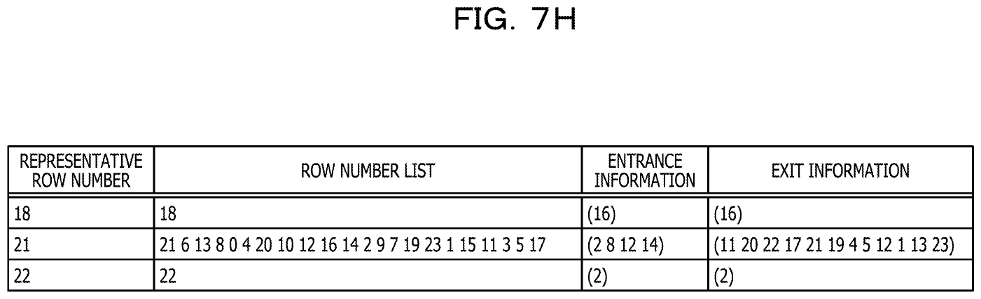

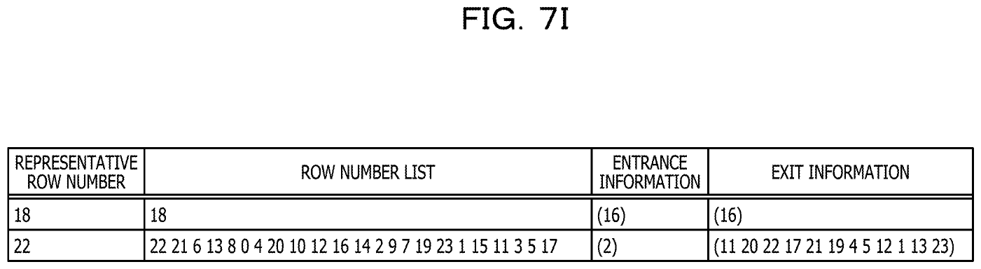

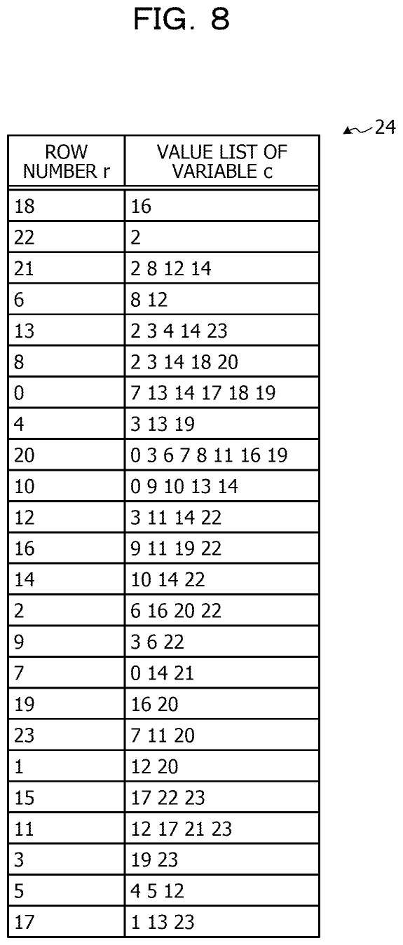

Then, the row sorting unit 12 refers to the row access information 23, sorts the rows to improve the reusability of the data arranged in the SPM, and generates the row sorting information 24 illustrated in FIG. 8. Here, the row sorting process performed by the row sorting unit 12 will be described with reference to FIGS. 7A to 7I. FIGS. 7A to 7I are diagrams each illustrating an example of the row sorting process. Note that the maximum number of slots of the SPM is assumed to be “12” here.

First, the row sorting unit 12 sets a start state of entrance information and exit information of each row from the row access information 23 (V1). Note that the initial state of the entrance information and the exit information of each row is set of values of the variable c to be accessed by each row. Here, as illustrated in FIG. 7A, the row sorting unit 12 sets, for a row number, a value list of the variable c as the initial state of the entrance information and the exit information. As an example, in a case where the row number is “0”, (7 13 14 17 18 19) is set for both the entrance information and the exit information.

Next, the row sorting unit 12 refers to the entrance information and the exit information of each row, and detects a pair of rows (X, Y) having, when X and Y indicating two rows are aligned in succession, the largest number of common elements between the exit information of the row X that comes first and the entrance information of the row Y that comes after (V2).

Then, when the row sorting unit 12 has succeeded in detecting the pair of rows (X, Y), it combines the pair of rows (X, Y) into a new row (V3). For example, the row sorting unit 12 sets the first element of the list of row numbers in the preceding row X as a representative row number of the new combined row. The list of row numbers of the new row is to be a list in which the row number list of the original row X and the row number list of the original row Y are aligned. Furthermore, the row sorting unit 12 sets, for the new combined row, the entrance information as the entrance information of the original row X, and sets the exit information as follows. For example, the row sorting unit 12 refers to the entrance information of each element included in the new row number list, and sets the set of values of the variable c as exit information. At this time, in a case where the size of the set exceeds the maximum number of slots of the SPM, the row sorting unit 12 deletes a value of the variable c with a low usage frequency.

In this manner, the row sorting unit 12 detects the pair of rows, and when the pair of rows is successfully detected, it repeats the processes V2 and V3 for combining the pair of rows into a new row (V4). Then, when the row sorting unit 12 fails to detect the pair of rows, there is no common element in the entrance information and the exit information of remaining rows, and thus it aligns the row number lists of the remaining rows in succession to make one row, and outputs the obtained row number list as a result of the row sorting (V5).

Here, the table in FIG. 7B is obtained by combining the pair of rows (13, 8) of the table in FIG. 7A into a new 13-row. For example, in the process V2, the row sorting unit 12 detects the pair of rows (13, 8) having the largest number of common elements. Then, in the process V3, the row sorting unit 12 sets the first element “13” of the row number list in the preceding 13-row as a representative row number of the new combined 13-row. Then, the row number list of the new row becomes “13, 8”. Furthermore, the row sorting unit 12 sets the entrance information for the new combined 13-row as the entrance information (2 3 4 14 23) of the original 13-row. The row sorting unit 12 refers to the entrance information of “13” and “8” included in the row number list of the new row, and sets the set of values of the variable c (4 23 2 3 14 18 20) as exit information. At this time, the size of the set is “7”, which does not exceed “12” indicating the maximum number of slots of the SPM, and thus the row sorting unit 12 keeps the exit information as it is.

The table in FIG. 7C is obtained by combining the pair of rows (13, 0) of the table in FIG. 7B into a new 13-row. For example, in the process V2, the row sorting unit 12 detects the pair of rows (13, 0) having the largest number of common elements. Then, in the process V3, the row sorting unit 12 sets the first element “13” of the row number list in the preceding 13-row as a representative row number of the new combined 13-row. Then, the row number list of the new row becomes “13, 8, 0”. Furthermore, the row sorting unit 12 sets the entrance information for the new combined 13-row as the entrance information (2 3 4 14 23) of the original 13-row. The row sorting unit 12 refers to the entrance information of “13”, “8”, and “0” included in the row number list of the new row, and sets the set of values of the variable c (4 23 2 3 20 7 13 14 18 19) as exit information. At this time, the size of the set is “10”, which does not exceed “12” indicating the maximum number of slots of the SPM, and thus the row sorting unit 12 keeps the exit information as it is.

The table in FIG. 7D is obtained by combining the pair of rows (13, 4) of the table in FIG. 7C into a new 13-row. For example, in the process V2, the row sorting unit 12 detects the pair of rows (13, 4) having the largest number of common elements. Then, in the process V3, the row sorting unit 12 sets the first element “13” of the row number list in the preceding 13-row as a representative row number of the new combined 13-row. Then, the row number list of the new row becomes “13, 8, 0, 4”. Furthermore, the row sorting unit 12 sets the entrance information for the new combined 13-row as the entrance information (2 3 4 14 23) of the original 13-row. The row sorting unit 12 refers to the entrance information of “13”, “8”, “0”, and “4” included in the row number list of the new row, and sets the set of values of the variable c (4 23 2 20 7 14 17 18 3 13 19) as exit information. At this time, the size of the set is “11”, which does not exceed “12” indicating the maximum number of slots of the SPM, and thus the row sorting unit 12 keeps the exit information as it is.

The table in FIG. 7E is obtained by combining the pair of rows (13, 20) of the table in FIG. 7D into a new 13-row. For example, in the process V2, the row sorting unit 12 detects the pair of rows (13, 20) having the largest number of common elements. Then, in the process V3, the row sorting unit 12 sets the first element “13” of the row number list in the preceding 13-row as a representative row number of the new combined 13-row. Then, the row number list of the new row becomes “13, 8, 0, 4, 20”. Furthermore, the row sorting unit 12 sets the entrance information for the new combined 13-row as the entrance information (2 3 4 14 23) of the original 13-row. The row sorting unit 12 refers to the entrance information of “13”, “8”, “0”, “4”, and “20” included in the row number list of the new row, and sets the set of values of the variable c (14 17 18 13 0 3 6 7 8 11 16 19) as exit information. At this time, the size of the set is “12”, which does not exceed “12” indicating the maximum number of slots of the SPM, and thus the row sorting unit 12 keeps the exit information as it is.

The table in FIG. 7F is obtained by combining the pair of rows (13, 10) of the table in FIG. 7E into a new 13-row. For example, in the process V2, the row sorting unit 12 detects the pair of rows (13, 10) having the largest number of common elements. Then, in the process V3, the row sorting unit 12 sets the first element “13” of the row number list in the preceding 13-row as a representative row number of the new combined 13-row. Then, the row number list of the new row becomes “13, 8, 0, 4, 20, 10”. Furthermore, the row sorting unit 12 sets the entrance information for the new combined 13-row as the entrance information (2 3 4 14 23) of the original 13-row. The row sorting unit 12 refers to the entrance information of “13”, “8”, “0”, “4”, “20”, and “10” included in the row number list of the new row, and sets the set of values of the variable c (3 6 7 8 11 16 19 0 9 10 13 14 17 18) as exit information. However, the size of the set is “14”, which exceeds “12” indicating the maximum number of slots of the SPM, and thus the row sorting unit 12 deletes the values of the variable c “17” and “18”, which are infrequently used.

In this manner, the row sorting unit 12 detects the pair of rows, and when the pair of rows is successfully detected, it repeats the processes V2 and V3 for combining the pair of rows into a new row (V4).

The table in FIG. 7G is obtained by combining a pair of rows (21, 5) of a table (not illustrated) into a new 21-row. The table in FIG. 7H is obtained by combining the pair of rows (21, 17) of the table in FIG. 7G into a new 21-row. The table in FIG. 7I is obtained by combining the pair of rows (22, 21) of the table in FIG. 7H into a new 22-row.

Then, since there is no common element in the entrance information and the exit information of the remaining rows, the row sorting unit 12 carries out the process V5. For example, the row sorting unit 12 aligns the row number lists of the remaining rows in succession to make one row, and outputs the obtained row number list as a result of the row sorting. As a result, the row sorting unit 12 generates the row sorting information 24 as illustrated in FIG. 8. For example, the row sorting unit 12 sorts the rows in such a manner that the degree of duplication of the non-zero data columns becomes higher, and generates the row sorting information 24.

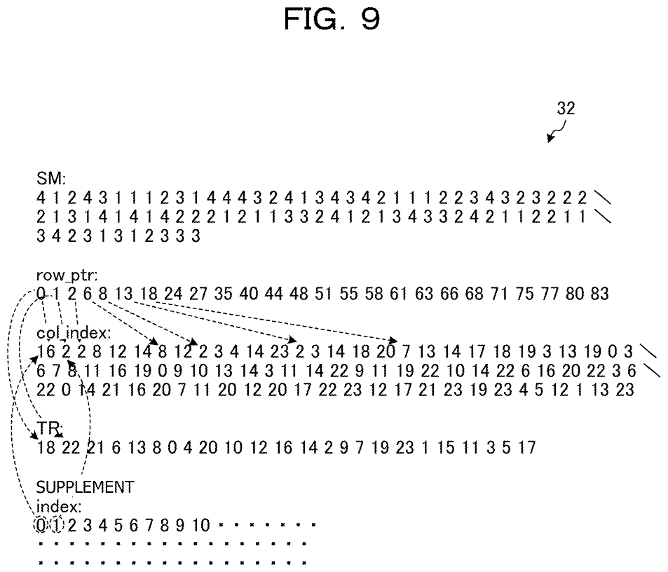

In addition, the row sorting unit 12 generates the sparse matrix information (CSR format) 32 after the row sorting using the row sorting information 24 illustrated in FIG. 8 and the sparse matrix information (CSR format) 31 before the row sorting illustrated in FIG. 5. FIG. 9 is a diagram illustrating the sparse matrix information (CSR format) after the row sorting. In FIG. 9, TR represents the row numbers after the sorting. A pointer indicating the same row (row) with respect to SM and col_index is represented by row_ptr. A list of values excluding zero values is represented by SM. A list of column numbers (col) of values excluding zero values is represented by col_index. As an example, in a case where row_ptr is “0 1 2 . . . ”, a zeroth to less than first value with respect to SM is a value of non-zero data “4” in the 18th row indicated by TR. In addition, it is indicated that a zeroth to less than first value with respect to col_index is a column number “16” of non-zero data in the 18th row indicated by TR.

Next, the row grouping unit 13 generates, from the row sorting information 24 illustrated in FIG. 8, the row grouping information 25 illustrated in FIG. 9 within a range not exceeding the number of slots of the SPM. It is assumed that the number of slots of the SPM is “12”. As illustrated in FIG. 9, the row grouping unit 13 groups the rows in order from the top of the row sorting information 24 within a range in which the number of nonequivalent values of the variable c does not exceed 12 indicating the number of slots of the SPM, and generates the row grouping information 25. As an example, in a case where the row number group is “18 22 21 6 13 8”, “2 3 4 8 12 14 16 18 20 23” is set as a value list of the variable c to be used.

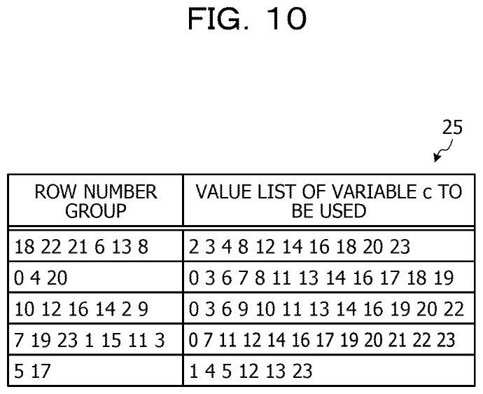

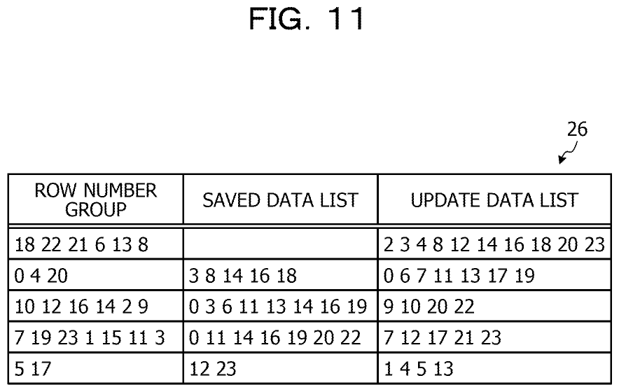

Next, the data rearrangement unit 14 refers to the row grouping information 25 in FIG. 10, and generates the data rearrangement information 26 in FIG. 11 for arranging, in the SPM, the data of the vector v corresponding to the variable c accessed by the processing of the grouped rows. In the data rearrangement information 26, the list of data (values of variable c) already saved in the SPM and the list of data (values of variable c) to be newly arranged (updated) in the SPM at the time point of starting the individual processes of the row number groups are set in association with each other. As an example, in a case where the row number group is “18 22 21 6 13 8”, “2 3 4 . . . 20 23” is set in the update data list while nothing is set in the saved data list. For example, it is indicated that, at the time point of starting the processing of “18 22 21 6 13 8” as a row number group, the data of the vector v corresponding to the values of the variable c “2 3 4 . . . 20 23” needs to be arranged (updated) while nothing is set in the SPM yet. Furthermore, in a case where the row number group is “0 4 20”, “0 6 7 . . . 17 19” is set in the update data list while “3 8 14 16 18” is set in the saved data list. For example, at the time point of starting the processing of “0 4 20” as a row number group, the data of the vector v corresponding to the values of the variable c “3 8 14 16 18” is already stored. In addition, it is indicated that the data of the vector v corresponding to the values of the variable c “0 6 7 . . . 17 19” needs to be arranged (updated).

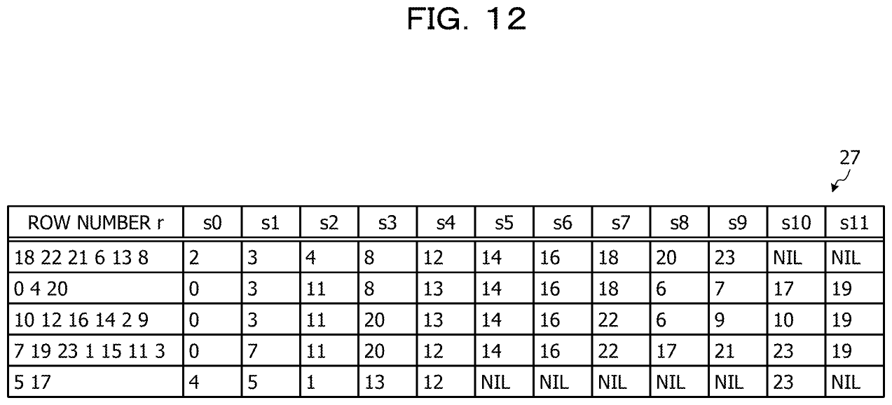

Next, the slot allocation unit 15 generates the slot allocation information 27 illustrated in FIG. 12 from the data rearrangement information 26 illustrated in FIG. 11. In the slot allocation information 27, a slot number and a value of the variable c included in the list of saved and updated data (values of variable c) are set in association with each other for each row number group. As an example, in a case where the row number group is “18 22 21 6 13 8”, “2” is set as a value of the variable c for the slot number “0”. For the slot number “1”, “3” is set as a value of the variable c. For the slot number “2”, “4” is set as a value of the variable c.

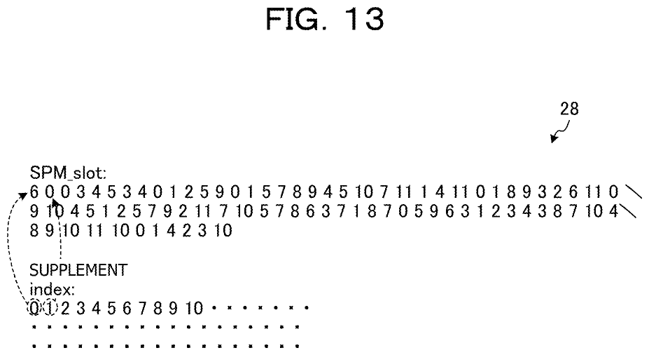

Furthermore, the slot allocation unit 15 generates the slot vector information 28 illustrated in FIG. 13 from the sparse matrix information 32 after the row sorting illustrated in FIG. 9 and the slot allocation information 27 illustrated in FIG. 12. The slot vector information 28 (SPM_slot) is used to obtain the slot number from the index variable index obtained from the sparse matrix information 32 after the row sorting. This is to obtain a slot number s from the index variable index instead of obtaining col_index from the index variable index. As an example, in the sparse matrix information 32 after the row sorting illustrated in FIG. 9, “16” is set as col_index and “18” is set as TR when index is “0”. Here, TR corresponds to the row number after the row sorting. Besides, col_index corresponds to the value of the variable c. Furthermore, it is understood from the slot allocation information 27 that the slot number when the row number after the row sorting is “18” and the value of the variable c is “16” is “6”. Therefore, in the slot vector information 28, the slot number corresponding to index “0” is set to “6”.

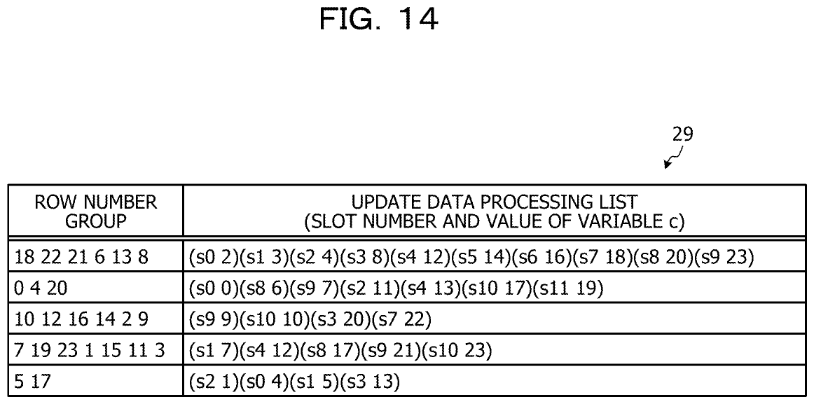

Furthermore, the slot allocation unit 15 generates the SPM setting information 29 illustrated in FIG. 14 from the slot allocation information 27 illustrated in FIG. 12. The SPM setting information 29 is used at the time of processing the grouped rows. As an example, in a case where the row number group is “18 22 21 6 13 8”, “(s0 2)(s1 3) . . . (s9 23)” is set.

In this manner, the initialization processing unit 100 according to the embodiment is executed.

Returning to FIG. 1, the data transfer unit 16 to be executed by the SPM setting function setup_SPM described in the post-conversion program 22 will be described. The data transfer unit 16 transfers the data of the vector v to the SPM. For example, at a time of processing rows for each group having been grouped, the data transfer unit 16 transfers only the data of the vector v corresponding to each value of the variable c to the slot indicated by the allocated slot number on the basis of the SPM setting information 29 in the processing of the first row in the group.

Here, a specific example of the data transfer unit 16 according to the embodiment will be described. Here, descriptions will be given using the SPM setting information 29 illustrated in FIG. 14.

First, the data transfer unit 16 checks whether the value of the parameter variable tr indicating the row number after sorting conversion given as an argument is the first row number of the row number group of the SPM setting information 29. In a case where the data transfer unit 16 determines that the value of the parameter variable tr is not the first row number of the row number group of the SPM setting information 29 as a result of the checking, it does not carry out the data transfer process. This is because the data transfer process has already been performed.

In a case where the data transfer unit 16 determines that the value of the parameter variable tr is the first row number of the row number group of the SPM setting information 29 as a result of the checking, it extracts the update data processing list corresponding to the row number group from the SPM setting information 29. As an example, in a case where the value of the parameter variable tr is “18”, the data transfer unit 16 extracts “(s0 2)(s1 3) . . . (s9 23)” as an update data processing list. Note that the first data in parentheses indicates a slot number, and the second data in parentheses indicates a value of the variable c.

Then, the data transfer unit 16 transfers the data of the vector v corresponding to the value of the variable c to the slot of the SPM using each element (slot number and value of variable c) included in the extracted update data processing list. As an example, the element (s0 2) indicates that the value of the vector v[2] is arranged (transferred) in the slot number “0” of the SPM. In a case where “(s0 2)(s1 3) . . . (s9 23)” is extracted as an update data processing list, the value of the vector v[2] is transferred to the slot number “0” of the SPM. The value of the vector v[3] is transferred to the slot number “1” of the SPM. The value of the vector v[23] is transferred to the slot number “9” of the SPM.

Thereafter, the data transfer unit 16 does not change the SPM state during the state where the value of the parameter variable tr is “22”, “21”, “6”, “13”, and “8”.

Next, in a case where the value of the parameter variable tr is “0”, the data transfer unit 16 determines that the value of the parameter variable tr is the first row number of the row number group of the SPM setting information 29. Accordingly, the data transfer unit 16 extracts “(s0 0)(s8 6) . . . (s11 19)” as an update data processing list. Then, the data transfer unit 16 changes the SPM state according to the extracted update data processing list.

Returning to FIG. 1, the data processing unit 17 processes the operation of A×v in the order of the sorted rows using the slot vector information 28 and the sparse matrix information 32 after the row sorting. For example, in a case where the row to be processed is tr, the data processing unit 17 obtains a range of index corresponding to the row of tr from row_ptr of the sparse matrix information 32. Then, the data processing unit 17 obtains a slot number s corresponding to each index using the slot vector information 28. Then, the data processing unit 17 obtains column data of the tr row corresponding to each index using SM of the sparse matrix information 32. Then, since the data of the vector v corresponding to the tr row is transferred (arranged) to the SPM by the data transfer unit 16, the data processing unit 17 processes the operation of A×v of the column data SM[index] of the tr row and the data SPM[s] of the vector v for the range of index.

As a result, the arithmetic processing device 1 is enabled to efficiently execute the processing of the vector v using the SPM by executing the post-conversion program 22 at the time of calculating the arithmetic equation r=A×v of the matrix A expressed in the sparse matrix format.

[Flowchart of Initialization Process (Init_SPM)]

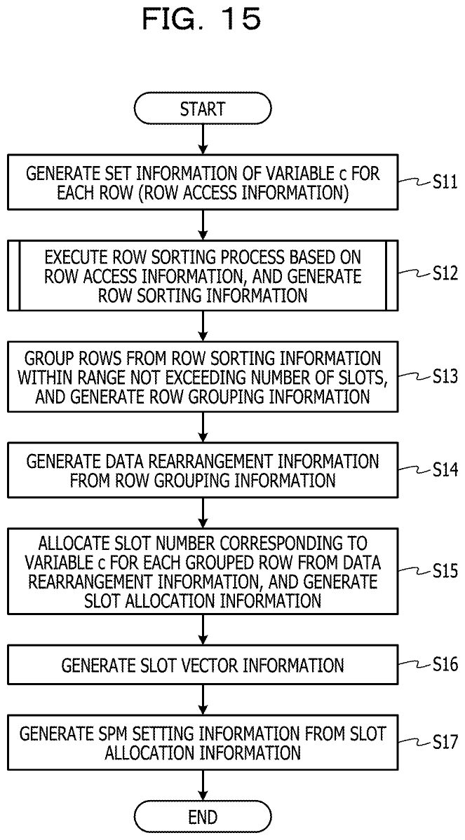

FIG. 15 is a diagram illustrating an exemplary flowchart of an initialization process (init_SPM) according to the embodiment. Note that the SPM initialization function init_SPM of the post-conversion program 22 is assumed to be executed.

First, the row sorting unit 12 generates, for the target sparse matrix, the set information of the variable c indicating the positions (column numbers) of the non-zero data for each row, and generates the row access information 23 (operation S11). Then, the row sorting unit 12 executes a row sorting process on the basis of the row access information 23, and generates the row sorting information 24 (operation S12). Note that the flowchart of the row sorting process will be described later.

Then, the row grouping unit 13 groups the rows from the row sorting information 24 within a range not exceeding the number of slots of the SPM, and generates the row grouping information 25 (operation S13). Then, the data rearrangement unit 14 generates the data rearrangement information 26 from the row grouping information 25 (operation S14). For example, the data rearrangement unit 14 generates the data rearrangement information 26 for arranging the data of the vector v corresponding to the variable c accessed by the processing of the grouped rows in the SPM.

Then, the slot allocation unit 15 allocates the slot number corresponding to the variable c (assigned to the data of the vector v) for each grouped row, and generates the slot allocation information 27 (operation S15). For example, the slot allocation unit 15 generates the slot allocation information 27 from the data rearrangement information 26.

Then, the slot allocation unit 15 generates the slot vector information 28 from the slot allocation information 27 and the sparse matrix information 32 after the row sorting expressed in the CSR format (operation S16). Then, the slot allocation unit 15 generates the SPM setting information 29 from the slot allocation information 27 (operation S17). Then, the initialization process (init_SPM) is terminated.

[Flowchart of Row Sorting Process]

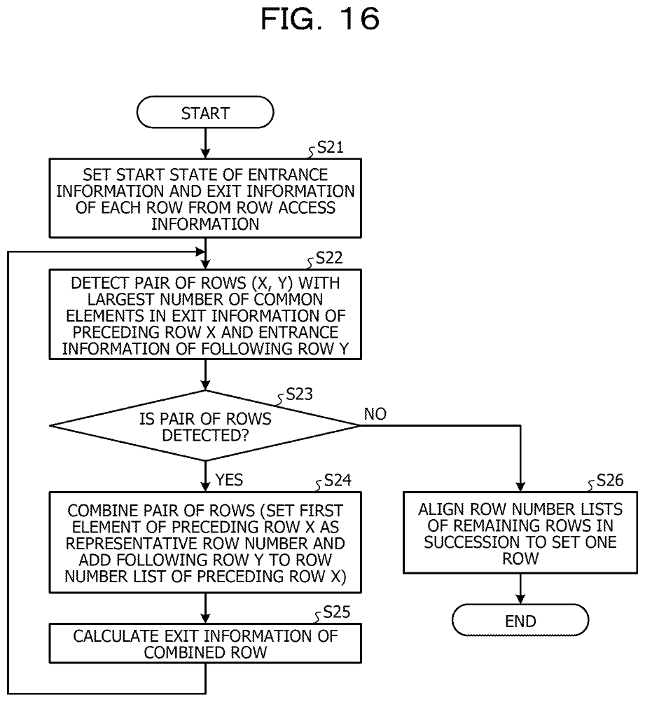

FIG. 16 is a diagram illustrating an exemplary flowchart of the row sorting process according to the embodiment. As illustrated in FIG. 16, the row sorting process sets a start state of the entrance information and the exit information of each row from the row access information 23 (operation S21). Then, the row sorting process detects the pair of rows (X, Y) having the largest number of common elements in the exit information of the preceding row X and the entrance information of the following row Y (operation S22).

Then, the row sorting process determines whether or not the pair of rows (X, Y) has been detected (operation S23). If it is determined that the pair of rows (X, Y) has been detected (Yes in operation S23), the row sorting process combines the pair of rows (X, Y) (operation S24). For example, the row sorting process sets the first element of the list of row numbers in the preceding row X as a representative row number of the new combined row. The list of row numbers of the new row is to be a list in which the row number list of the original row X and the row number list of the original row Y are aligned. Furthermore, the row sorting process sets the entrance information for the new combined row as the entrance information of the original row X.

In addition, the row sorting process calculates the exit information of the combined row (operation S25). For example, the row sorting process refers to the entrance information of each element included in the new combined row number list, and sets the set of values of the variable c as exit information. At this time, if the size of the set exceeds the maximum number of slots of the SPM, the row sorting process deletes a value of the variable c with a low usage frequency. Then, the row sorting process proceeds to operation S22 to detect the next pair of rows (X, Y).

If it is determined in operation S23 that the pair of rows (X, Y) is not detected (No in operation S23), the row sorting process sets one row by aligning the row number lists of the remaining rows in succession (operation S26). As a result, the row sorting process uses this row number list of one row as a row sorting result. Then, the row sorting process is terminated.

[Flowchart of Data Transfer Process (setup_SPM)]

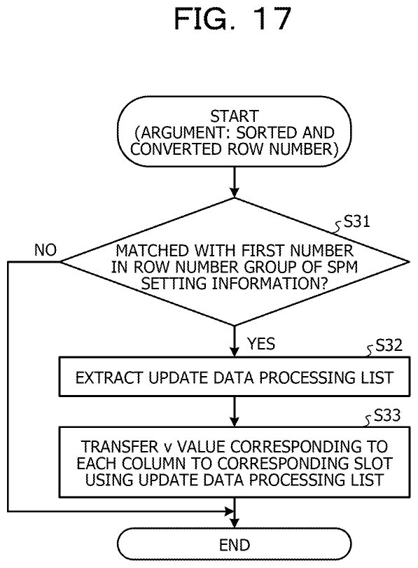

FIG. 17 is a diagram illustrating an exemplary flowchart of the data transfer process (setup_SPM) according to the embodiment. Note that the data transfer unit 16 is assumed to receive the vector v and the row number tr having been subject to the sorting conversion as arguments. As illustrated in FIG. 17, the data transfer unit 16 determines whether or not the converted row number matches the first number in the row number group of the SPM setting information 29 (operation S31).

If it is determined that the converted row number matches the first number in the row number group of the SPM setting information 29 (Yes in operation S31), the data transfer unit 16 extracts the update data processing list corresponding to the row number group from the SPM setting information 29 (operation S32). Then, the data transfer unit 16 transfers the data of the vector v corresponding to each value of the variable c to the slot indicated by each slot number using the update data processing list (operation S33). Then, the data transfer unit 16 terminates the data transfer process.

If it is determined in operation S31 that the converted row number does not match the first number in the row number group of the SPM setting information 29 (No in operation S31), the data transfer unit 16 terminates the data transfer process.

As a result, the arithmetic processing device 1 is enabled to efficiently execute the processing of the vector v using the SPM by executing the post-conversion program 22 at the time of calculating the arithmetic equation r=A×v of the matrix A expressed in the sparse matrix format. Furthermore, at the time of executing the operation of r=A×v using the post-conversion program 22, the vector v may be different at each execution time even when the sparse matrix information of the matrix A is the same. Even in such a case, once the slot vector information 28 (see FIG. 13), the SPM setting information 29 (see FIG. 14), and the sparse matrix information 32 after the row sorting (see FIG. 9) generated by the call of the SPM initialization function init_SPM are generated, the arithmetic processing device 1 is enabled to use them without modification. As a result, the arithmetic processing device 1 is enabled to execute the operation of r=A×v at high speed.

### Effects of Embodiment

According to the embodiment described above, the arithmetic processing device 1 groups the rows having columns of non-zero data within a range not exceeding the slot size of the scratchpad memory at the time of calculating the arithmetic equation r=A×v of the matrix A expressed in the sparse matrix format. The arithmetic processing device 1 allocates the slot to each column of the non-zero data in the grouped rows. At the time of processing the rows for each group, the arithmetic processing device 1 transfers only the data of the vector v corresponding to each column to the slot allocated to each column in the processing of the first row of the group. According to such a configuration, the arithmetic processing device 1 is enabled to use the scratchpad memory for the processing of the data of the vector v at the time of calculating the arithmetic equation r=A×v of the matrix A expressed in the sparse matrix format. Then, the arithmetic processing device 1 transfers only the necessary data of the vector v to the scratchpad memory, thereby improving the efficiency in the use of the scratchpad memory.

Furthermore, according to the embodiment described above, the arithmetic processing device 1 groups a plurality of rows having a higher degree of duplication of the non-zero data columns. According to such a configuration, the arithmetic processing device 1 is enabled to improve the reusability of the data of the vector v arranged as a result of the transfer to the scratchpad memory.

Furthermore, according to the embodiment described above, the arithmetic processing device 1 sorts the rows in such a manner that the degree of duplication of the non-zero data columns becomes higher, and groups the rows within a range not exceeding the slot size of the scratchpad memory on the basis of the row sorting information. According to such a configuration, the arithmetic processing device 1 is enabled to improve the reusability of the data of the vector v as a result of the transfer to the scratchpad memory in the processing of the grouped rows. As a result, the arithmetic processing device 1 is enabled to improve the efficiency in the use of the scratchpad memory.

Others

Note that each component of the arithmetic processing device 1 is not necessarily physically configured as illustrated in the drawings. For example, specific aspects of separation and integration of the arithmetic processing device 1 are not limited to the illustrated ones, and all or a part thereof may be functionally or physically separated or integrated in any unit depending on various loads, use states, and the like. For example, the row sorting unit 12 may be separated into a functional unit for row sorting and a functional unit for generating the sparse matrix information 32 after the row sorting. Furthermore, the row sorting unit 12 and the row grouping unit 13 may be integrated as one unit. Furthermore, the storage unit 20 may be connected via a network as an external device of the arithmetic processing device 1.

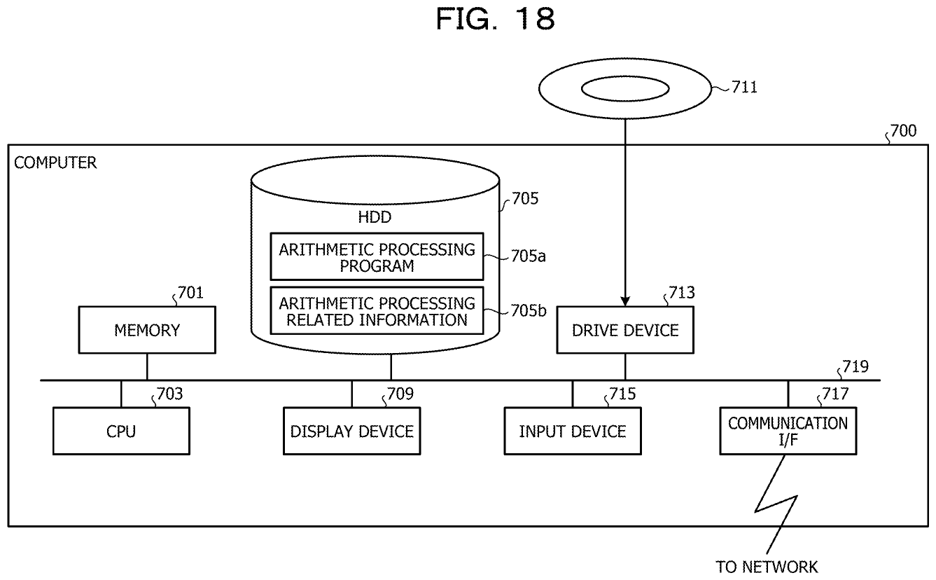

Furthermore, various types of processing described in the embodiment above may be implemented by a computer such as a personal computer or a workstation executing programs prepared in advance. In view of the above, hereinafter, an exemplary computer that executes an arithmetic processing program for implementing functions similar to those of the arithmetic processing device 1 illustrated in FIG. 1 will be described. FIG. 18 is a diagram illustrating an exemplary computer that executes the arithmetic processing program.

As illustrated in FIG. 18, a computer 700 includes a CPU 703 that executes various types of arithmetic processing, an input device 715 that receives data input from a user, and a display control unit 707 that controls a display device 709. Furthermore, the computer 700 includes a drive device 713 that reads a program and the like from a storage medium, and a communication control unit 717 that exchanges data with another computer via a network. Furthermore, the computer 700 includes a memory 701 that temporarily stores various types of information, and a Hard Disk Drive (HDD) 705. Additionally, the memory 701, the CPU 703, the HDD 705, the display control unit 707, the drive device 713, the input device 715, and the communication control unit 717 are connected by a bus 719.

The drive device 713 is, for example, a device for a removable disk 711. The HDD 705 stores an arithmetic processing program 705a and arithmetic processing related information 705b.

The CPU 703 reads the arithmetic processing program 705a, loads it into the memory 701, and executes it as a process. Such a process corresponds to each functional unit of the arithmetic processing device 1. The arithmetic processing related information 705b corresponds to the post-conversion program 22, the row access information 23, the row sorting information 24, the sparse matrix information (after row sorting) 32, the row grouping information 25, the data rearrangement information 26, and the like. Then, for example, the removable disk 711 stores each piece of information such as the arithmetic processing program 705a.

Note that the arithmetic processing program 705a may not necessarily be stored in the HDD 705 from the beginning. For example, the program may be stored in a “portable physical medium” to be inserted in the computer 700, such as a Flexible Disk (FD), a Compact Disc Read only memory (CD-ROM), a Digital Versatile Disc (DVD), a magneto-optical disk, an Integrated Circuit (IC) card, or the like. Then, the computer 700 may read the arithmetic processing program 705a from those media to execute it.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an arithmetic processing program that causes a computer to execute a process, the process comprising:
in a case of obtaining a result of product (r=A×v) of a matrix A expressed in a sparse matrix format and a vector v,
grouping rows with a column of non-zero data within a range that does not exceed a slot size of a scratchpad memory;
allocating a slot to each column of the non-zero data in the grouped rows; and
transferring, at a time of processing the rows for each group, data of the vector v that corresponds to each column to the slot allocated to each column in processing of a first row of the group.

2. The non-transitory computer-readable recording medium according to claim 1, wherein
the grouping groups a plurality of the rows that include a higher degree of duplication of the column of the non-zero data among the rows with the column of non-zero data.

3. The non-transitory computer-readable recording medium according to claim 2, wherein
the grouping sorts the rows such that the degree of duplication of the column of the non-zero data becomes higher and groups the rows within the range, based on sorting information of the rows.

4. An arithmetic processing method that causes a computer to execute a process, the process comprising:
grouping rows with a column of non-zero data within a range that does not exceed a slot size of a scratchpad memory in a case of obtaining a result of product (r=A×v) of a matrix A expressed in a sparse matrix format and a vector v;
allocating a slot to each column of the non-zero data in the grouped rows; and
transferring, at a time of processing the rows for each group, data of the vector v that corresponds to each column to the slot allocated to each column in processing of a first row of the group.

5. An arithmetic processing apparatus comprising:
a memory; and
a processor coupled to the memory and configured to:
group rows with a column of non-zero data within a range that does not exceed a slot size of a scratchpad memory in a case of obtaining a result of product (r=A×v) of a matrix A expressed in a sparse matrix format and a vector v;
allocate a slot to each column of the non-zero data in the grouped rows; and
transfer, at a time of processing the rows for each group, data of the vector v that corresponds to each column to the slot allocated to each column in processing of a first row of the group.
